(19) United States
(12) Patent Application Publication
(10) Pub. No.: US 2010/0262416 A1
(43) Pub. Date: Oct. 14, 2010

(54) COMPUTER AND METHOD FOR SIMULATING AN ATTENTION COMMAND TEST OF A MOBILE PHONE

(75) Inventor: LI-HAI CHEN, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); CHI MEI COMMUNICATION SYSTEMS, INC., Tu-Cheng City (TW)

(21) Appl. No.: 12/630,937

(22) Filed: Dec. 4, 2009

(30) Foreign Application Priority Data
Apr. 11, 2009 (CN) 200910301491.2

(51) Int. Cl. G06G 7/62

(52) U.S. Cl. 703/20

(57) ABSTRACT

A system and method for simulating an attention (AT) command test of a mobile phone reads an AT function from an AT script file. If the AT function is a passive request function, the AT function is executed directly. If the AT function is an active request function, the system receives an AT request from an application program of the mobile phone. The AT request is converted into environment variables recognizable by the AT script file. If the environment variables match the AT function, the AT function is executed and an AT response is generated. The application program receives the AT response.

### BACKGROUND

1. Technical Field

Embodiments of the present disclosure relate to attention (AT) command testing, and more particularly to a computer and method for simulating an AT command test of a mobile phone.

2. Description of Related Art

At present, a method of simulating AT command test of a mobile phone comprises setting a series of AT commands in a file. If an application program in a terminal equipment (TE) sends an AT request, a simulator searches items in the file according to the AT request. Accordingly, the simulator sends a predefined AT response to the application program. The method of simulating AT command test needs to be supported by the TE, but the TE may be expensive.

What is needed, therefore, is an improved computer and method for simulating AT command test of a mobile phone.

### BRIEF DESCRIPTION OF THE DRAWINGS

FIG. 1 is a block diagram of one embodiment of a simulating system for simulating an AT command test of a mobile phone.

FIG. 2 is a block diagram of functional modules of the simulating system in FIG. 1.

FIG. 3 is a flowchart of one embodiment of a method for simulating an AT command test of a mobile phone.

### DETAILED DESCRIPTION

All of the processes described below may be embodied in, and fully automated via, functional modules executed by one or more general purpose processors. The functional modules may be stored in any type of computer-readable medium or other computer storage device. Some or all of the methods may alternatively be embodied in specialized computer hardware or communication apparatus.

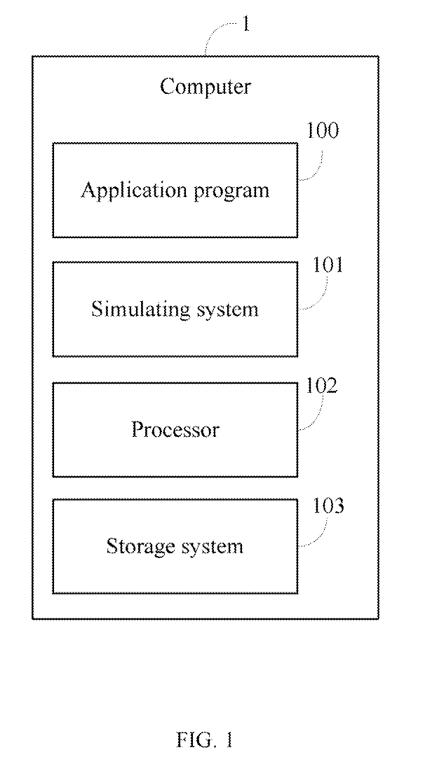

FIG. 1 is a block diagram of one embodiment of a computer 1 comprising a simulating system 101. The simulating system 101 may be used to simulate an attention (AT) command test of a mobile phone. The computer 1 includes an application program 100 of the mobile phone. The application program 100 sends AT requests to the simulating system 101. In one embodiment, the application program 100 may be a call managing program, or a short message program. The AT requests may be a short message request or a dialing phone call request. The computer 1 includes a processor 102 and a storage system 103. The processor 102 executes one or more computerized operations of the computer 1 and other applications, to provide the functions of the computer 1.

The storage system 103 stores an AT script file. In one embodiment, the AT script file is described by the extensible markup language (XML). The AT script file includes a plurality of AT functions. Each AT function includes a plurality of instructions. In one embodiment, the AT function may be for dialing a phone number.

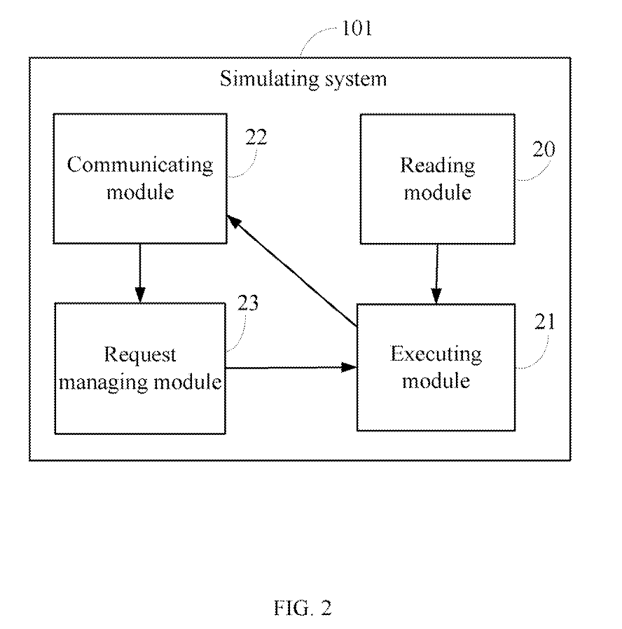

FIG. 2 is a block diagram of functional modules of the simulating system 101 in FIG. 1. In one embodiment, the simulating system 101 may include a reading module 20, an executing module 21, a communicating module 22, and a request managing module 23. It may be understood that the processor 102 may be used to execute one or more computerized codes of the functional modules 20-23. The one or more computerized codes of the functional modules 20-23 may be stored in the storage system 103.

The reading module 20 reads an AT function from the AT script file stored in the storage system 103.

In one embodiment, the AT function may be an active request function or a passive request function. The executing module 21 detects if the AT function is the active request function or the passive request function. If the AT function is the passive request function, the executing module 21 executes instructions of the AT function. If the AT function is the active request function, the executing module 21 waits to receive an AT request from the application program 100. In one example, an AT function is the active request function if the AT function is to call a phone number. In another example, an AT function is the passive request function if the AT function is to receive a call.

The communicating module 22 receives the AT request sent from the application program 100, and sends the AT request to the request managing module 23.

The request managing module 23 generates a queue that lists AT requests sent from the communicating module 22. The request managing module 23 inserts a received AT request into one end of the queue, and obtains an AT request from the other end of the queue. Once an AT request is obtained from the queue, the AT request is deleted from the queue. The request managing module 23 converts the obtained AT request into environment variables recognizable by the AT script file. In one embodiment, an environment variable may include a “%” symbol and a positive integer. For example, the request managing module 23 obtains an AT request for setting parameters. An item of instructions of the AT function is “ATCMD=P1, P2, P3.” The “ATCMD” is a command name. The “=” is a sign for assigning. The “P1,” “P2,” and “P3” are the parameter assigned. The command name is converted into the environment variable “% 0.” The parameter “P1” is converted into “% 1.” The parameter “P2” is converted into “% 2.” The parameter “P3” is converted into “% 3.”

The request managing module 23 detects if the environment variables correspond to the AT function. For example, if the AT function of the mobile phone is for dialing a call, but the environment variables are for sending short message, the request managing module 23 determines that the environment variables does not match the AT function.

If the environment variables does not match the AT function, the communicating module 22 signals the application program 100 that the AT request sent from the application program 100 cannot be performed. If the environment variables match the AT function, the executing module 21 executes the AT function, and generates an AT response corresponding to the environment variables. The communicating module 22 sends the AT response to the application program 100. The reading module 20 also detects if there is any AT function which have not been read in the AT script file. If there is any AT function which have not been read, the reading module 20 reads a next function from the AT script file.

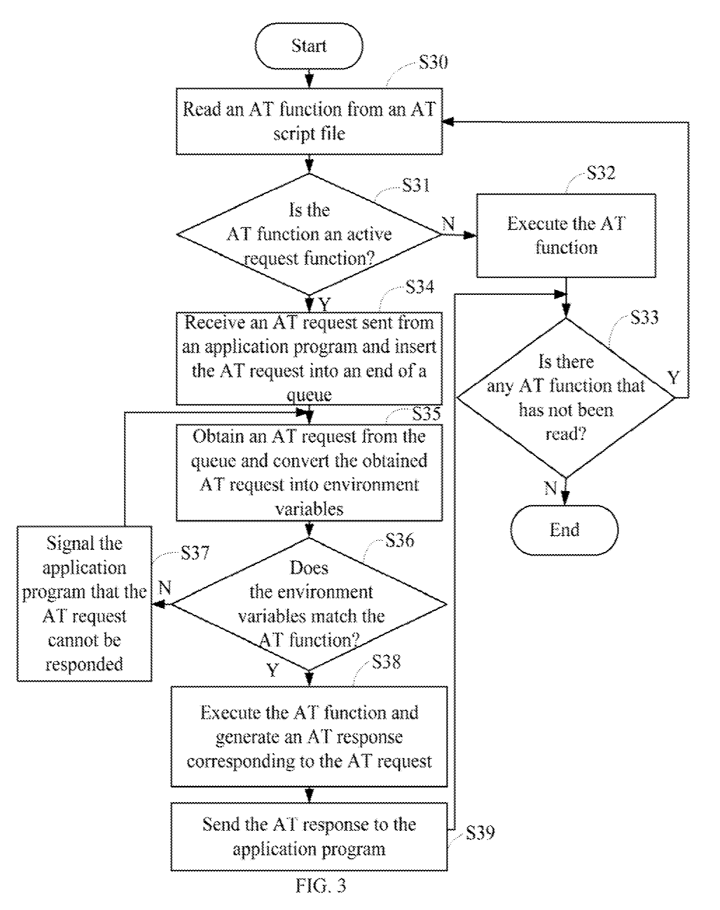

FIG. 3 is a flowchart of one embodiment of a method for simulating an attention (AT) commands test of a mobile phone. Depending on the embodiment, additional blocks may be added, others removed, and the ordering of the blocks may be changed.

In block S30, the reading module 20 reads an AT function from the AT script file stored in the storage system 103.

In block S31, the executing module 21 detects if the AT function is the active request function or the passive request function. If the AT function is the active request function, block S34 is implemented. If the AT function is the passive request function, block S32 is implemented.

In block S32, the executing module 21 executes the AT function, and the procedure goes to block S33.

In block S33, the reading module 20 detects if there is any AT function that has not been read in the AT script file. If all the AT functions in the AT script file have been read, the procedure ends. If there is any AT function that has not been read in the AT script file, block S30 is repeated.

In block S34, the communicating module 22 receives an AT request sent from the application program 100 of the mobile phone and sends the AT request to the request managing module 23. The request managing module 23 generates a queue and inserts the AT request into one end of the queue.

In block S35, the request managing module 23 obtains an AT request from the other end of the queue and converts the obtained AT request into environment variables recognizable by the AT script file.

In block S36, the request managing module 23 detects if the environment variables match the AT function. If the environment variables match the AT function, block S38 is implemented. If the environment variables does not match the AT function, block S37 is implemented.

In block S37, the communicating module 22 signals the application program 100 that the AT request sent from the application program cannot be performed, and block S35 is repeated.

In block S38, the executing module 21 executes the AT function and generates an AT response corresponding to the environment variables.

In block S39, the communicating module 22 sends the AT response to the application program 100.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computer for simulating an attention (AT) command test of a mobile phone comprising:
a storage system; and
at least one processor to execute one or more programs stored in the storage system, the one or more programs comprising:
a reading module operable to read an AT function from an AT script file stored in the storage system;
an executing module operable to detect if the AT function is an active request function or a passive request function, and execute the AT function if the AT function is the passive request function;
a communicating module operable to receive an AT request sent from an application program of the mobile phone if the AT function is the active request function;
a request managing module operable to convert the AT request into environment variables recognizable by the AT script file;
the executing module further operable to execute the AT function if the environment variables match the AT function, and generate an AT response match the environment variables; and
the communicating module further operable to send the AT response to the application program.

2. The computer of claim 1, wherein the request managing module is further operable to generate a queue that lists AT requests, insert an AT request into one end of the queue, and obtain another AT request from the other end of the queue.

3. The computer of claim 2, wherein the AT request is converted into the environment variables according to an obtain sequence from the queue.

4. The computer of claim 1, wherein the communicating module is further operable to signal the application program that the AT request sent from the application program cannot be performed if the environment variables does not match the AT function.

5. The computer of claim 4, wherein the reading module is further operable to detect if there is any AT function which has not been read in the AT script file, and read a next AT function if the AT function has not been read.

6. A method for simulating an attention (AT) commands test of a mobile phone, the method comprising:
(a) reading an AT function from an AT script file by a computer;
(b) executing the AT function if the AT function is a passive request function, and ending the procedure; or
(c) receiving an AT request sent from an application program of the mobile phone if the AT function is an active request function;
(d) converting the AT request into environment variables recognizable by the AT script file;
(e) executing the AT function if the environment variables match the AT function, and generating an AT response match the environment variables; and
(f) sending the AT response to the application program.

7. The method of claim 6, before block (d) further comprising:
generating a queue that lists AT requests;
inserting the received AT request into one end of the queue; and
obtaining another AT request from the other end of the queue.

8. The method of claim 7, wherein the AT request is converted into the environment variables according to an obtaining sequence from the queue.

9. The method of claim 6, after block (d) further comprising:
signaling the application program that the AT request sent from the application program cannot be performed if the environment variables does not match the AT function.

10. The method of claim 6, further comprising:
detecting if there is any AT function which has not been read in the AT script file,
repeating block (a) to block (e) if there is any AT function which has not been read in the AT script file; and
ending the procedure if all of the AT functions in the AT script file have been read.

11. A storage medium having stored therein instructions that, when executed by a computer, cause the computer to perform a method for simulating an attention (AT) commands test of a mobile phone comprising:
(a) reading an AT function from an AT script file by a computer;
(b) executing the AT function if the AT function is a passive request function, and ending the procedure; or
(c) receiving an AT request sent from an application program of the mobile phone if the AT function is an active request function;
(d) converting the AT request into environment variables recognizable by the AT script file;
(e) executing the AT function if the environment variables match the AT function, and generating an AT response match the environment variables; and
(f) sending the AT response to the application program.

12. The medium of claim 11, before block (d) further comprising:
generating a queue that lists AT requests;
inserting the received AT request into one end of the queue; and
obtaining another AT request from the other end of the queue.

13. The medium of claim 12, wherein the AT request is converted into the environment variables according to an obtaining sequence from the queue.

14. The medium of claim 11, after block (d) further comprising:
signaling the application program that the AT request sent from the application program cannot be performed if the environment variables does not match the AT function.

15. The medium of claim 11, further comprising:
detecting if there is any AT function which has not been read in the AT script file,
repeating block (a) to block (e) if there is any AT function which has not been read in the AT script file; and
ending the procedure if all of the AT functions in the AT script file have been read.
